(19) United States
(12) Patent Application Publication
(10) Pub. No.: US 2003/0023698 A1
(43) Pub. Date: Jan. 30, 2003

(54) Method and apparatus for remotely configuring and displaying information

(75) Inventors: Andreas Dieberger, San Jose, CA (US); Christine A. Halverson, San Jose, CA (US); Peter K. Malkin, Arsdley, NY (US)

Correspondence Address: Frank Chau, F. CHAU & ASSOCIATES, LLP, Suite 501, 1900 Hempstead Turnpike, East Meadow, NY, 11554, US

(73) Assignee: International Business Machines Corporation, Armonk, NY (US)

(21) Appl. No.: 09/915,049

(22) Filed: Jul. 25, 2001

(51) Int. Cl. G06F 15/16; G06F 17/60

(52) U.S. Cl. 709/207; 709/217

(57) ABSTRACT

According to an embodiment of the present invention, a method is provided for displaying content on a display device. The method includes retrieving a plurality of rules for the display of content, updating a plurality of device parameters, and determining an rule trigger. The method further includes executing a rule corresponding to the rule trigger, and determining a fee according to at least one device parameter upon executing a rule for the display of content. At least one rule is defined by a content provider to dynamically control the display of the content according to the device parameters. Determining a fee further comprises determining a value for each of the device parameters, determining at least one device parameter satisfying the rule, and determining the fee according to value of the device parameters satisfying the rule.

### BACKGROUND OF THE INVENTION

1. Field of the Invention

The present invention relates to configurable display devices and more particularly, a method of correlating fees to parameter-based triggered display of content.

2. Discussion of the Prior Art

Readily available information has become a ubiquitous facet of today's society. The information can take many forms, for example, entertainment and advertisement. The exchange of information has spawned an industry based on supplying the public's seemingly insatiable demand for information. Because providing information can become expensive, targeting an audience known to be more likely to respond to the information has become an important factor in increasing the effectiveness of the information provided. For example, an advertisement for golf clubs on a billboard may be more effective when placed near a country club (the point of purchase).

Billboards are typically stationary and do not display content dynamically. Content shown on billboards may have been determined based on where the billboard is located, however, the content is not based on changing parameters, e.g., variables such as the time of day or the demographics of an audience. There are billboards that change content (e.g., billboards having rotating louvers), but not according to any particular parameter. Further, mobile billboards (e.g., signs on buses, or sandwich-boards on humans) are not able to change content or adapt fees dynamically based on a current location.

Content may be provided by car radios, which are mobile devices. However, location dependency can be crude, based on radio reception coverage. Further, content does not interact with location in a dynamic and intuitive manner. Furthermore, radios are typically the personal property of an owner, but are not personally identifiable with the owner as a T-shirt, backpack, or jewelry can be.

T-shirts can be used as advertising, however, a T-shirt is typically limited to print type advertising. Work at the Massachusetts Institute of Technology and Stanford University has shown that cloth can be embedded electronic displays and pigments sensitive to black lights. However, these do not allow for parameter based flexibility.

Some devices have limited environmental awareness, such as screens located in subways which show programming between the arrival of trains. As a train approaches the platform, these screens suspend programming and announce the arrival of the train. However, these screens do not allow the advertiser to select the particular locations where the advertisements are shown, rather the advertisements are shown across the entire television network.

No known system or method currently exists for dynamically changing content and adapting fees based on local variables. Therefore, a need exists for a method of correlating fees to parameter-based triggered display of content.

### SUMMARY OF THE INVENTION

According to an embodiment of the present invention, a method is provided for displaying content on a display device. The method includes retrieving a plurality of rules for the display of content, updating a plurality of device parameters, and determining an rule trigger. The method further includes executing a rule corresponding to the rule trigger, and determining a fee according to at least one device parameter upon executing a rule for the display of content.

At least one rule is defined by a content provider to dynamically control the display of the content according to the device parameters.

Executing a rule further comprises the step of receiving a rule trigger from one of a location handler and a signal handler. Receiving a rule trigger from the location handler further comprises the step of updating a positional parameter. Receiving a rule trigger from the signal handler further comprises interpreting an input signal, and generating a programmatic event flag. Generating a programmatic event flag further comprises the step of generating one of a reply signal and the rule trigger.

The method includes providing an overriding rule blocking the display of content corresponding to the rule and the determination of the fee, wherein the overriding rule is defined by the device owner.

Determining a fee further comprises determining a value for each of the device parameters, determining at least one device parameter satisfying the rule, and determining the fee according to value of the device parameters satisfying the rule.

The method further comprises charging the fee to a client providing content to be displayed. The method comprises apportioning the fee between a service provider and a third party carrier of the display device. The method further comprises apportioning the fee between an owner of the device and a third party carrier of the display device. The method includes the step of apportioning the fee between a plurality of owners of a plurality of devices, wherein the devices act as a composite device.

The fee can be charged to a user for the use of the display.

According to an embodiment of the present invention, a method is provided for displaying content on a mobile display device. The method includes retrieving a plurality of rules stored in the mobile display device from a rule server, determining a value for each of a plurality of device parameters, and determining an rule trigger calling at least one rule. The method further includes determining whether each rule is satisfied by the device parameters, displaying content corresponding to each satisfied rule, and determining a monetary charge based on the device parameters satisfying each rule.

At least one rule is defined by a content provider to dynamically control the display of the content according to the device parameters.

The method includes receiving a rule trigger from one of a location handler and a signal handler. Receiving a rule trigger from the location handler further comprises the step of updating a positional parameter. Receiving a rule trigger from the signal handler further comprises interpreting an input signal, and generating a programmatic event flag. Generating a programmatic event flag further comprises the step of generating one of a reply signal and the rule trigger.

According to an embodiment of the present invention, a program storage device is provided, readable by machine, tangibly embodying a program of instructions executable by the machine to perform method steps for displaying content on a display device. The method includes retrieving a plurality of rules for the display of content, updating a plurality of device parameters, determining an rule trigger, executing a rule corresponding to the rule trigger, and determining a fee according to at least one device parameter upon executing a rule for the display of content.

### BRIEF DESCRIPTION OF THE FIGURES

The foregoing and other objects, aspects, and advantages will be better understood from the following non limiting detailed description of preferred embodiments of the invention with reference to the drawings that include the following:

FIG. 1 is an illustrative example of the operation of a Mobile Display Device (MDD) in an environment according to an embodiment of the present invention;

FIG. 2 show the hardware architecture of a MDD according to an embodiment of the present invention;

FIG. 3 is a flow diagram of the of the Mobile Device Program's logic according to an embodiment of the present invention;

FIG. 4 is a flow diagram of the current invention's business process according to an embodiment of the present invention;

FIG. 5 is an example of data displayed on a car-mounted display according to an embodiment of the present invention; and

FIG. 6 illustrates the network topology according to an embodiment of the present invention.

### DETAILED DESCRIPTION OF PREFERRED EMBODIMENTS

According to an embodiment of the present invention, content can be triggered by one or more parameters satisfying a rule. These parameters can include time, weather, the location of the device, the proximity of other like devices, etc. According to an embodiment of the present invention, the fee arrangement between the owner of the device and a content provider can be adjusted according to one or more of the parameters.

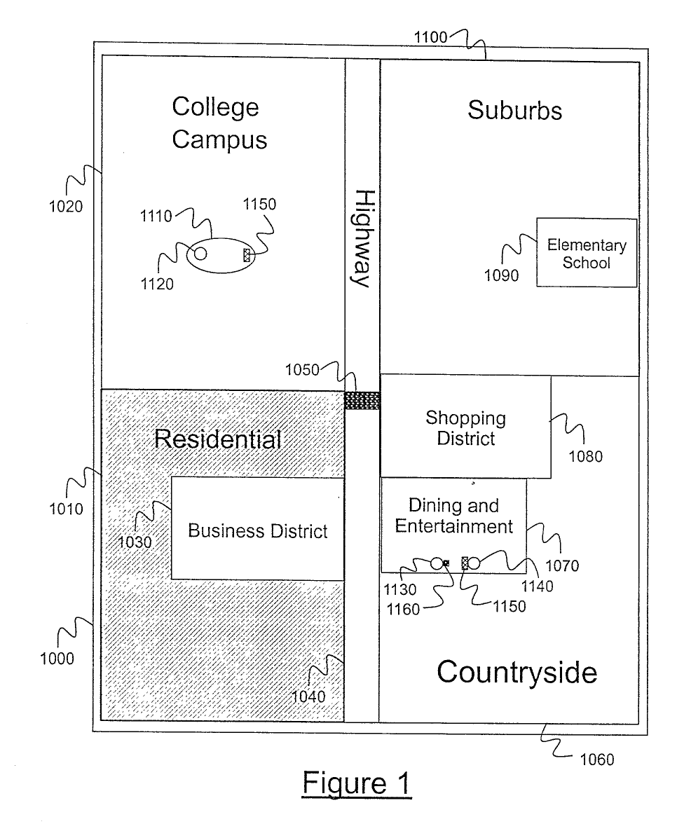

Referring to FIG. 1, depicting an example of an embodiment of the present invention, area 1000 includes several regions including a densely populated urban residential area 1010; a college campus 1020; a business district 1030; a highway 1040, including a toll plaza 1050; a sparsely populated countryside 1060; a dining and entertainment district 1070; a shopping district 1080; and a suburban section 1100 including an elementary school 1090. Also depicted in FIG. 1, is a Mobile Display Device (MDD) 1150a fixed to an automobile 1110, and two individuals, 1130 and 1140, where individual 1140 is carrying MDD 1150b.

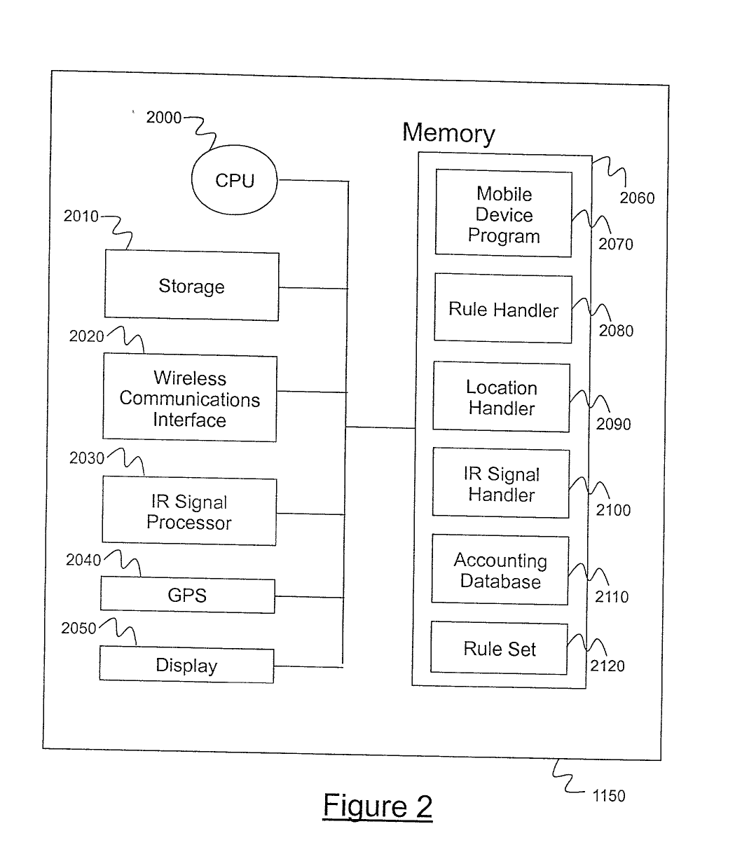

FIG. 2 depicts an MDD 1150, including inter alia, a central processing unit (CPU) 2000; a storage device 2010, such as a programmable nonvolatile random access memory (RAM) or direct access storage device (DASD); a wireless communications interface 2020 (e.g., including, but not limited to those supported by IEEE standards 802.11a and 802.11b, and developing standard 802.11g); an infrared (IR) signal processor 2030; a Global Positioning System (GPS) 2040; a display 2050; and memory 2060, such as RAM. According to the present invention, a Mobile Device Program (MDP) 2070 is preferably embodied as computer executable code, e.g., Java or C++, loaded from storage 2010 into memory 2060 for execution by the CPU 2000. The memory 2060 stores the MDP 2070, a Rule Handler 2080, a Location Handler 2090, an IR Signal Handler 2100, an Accounting Database 2110, and Rule Set 2120. The MDD 11500 can run on any mobile computing node, such as an IBM ThinkPad®, or palmtop computer.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

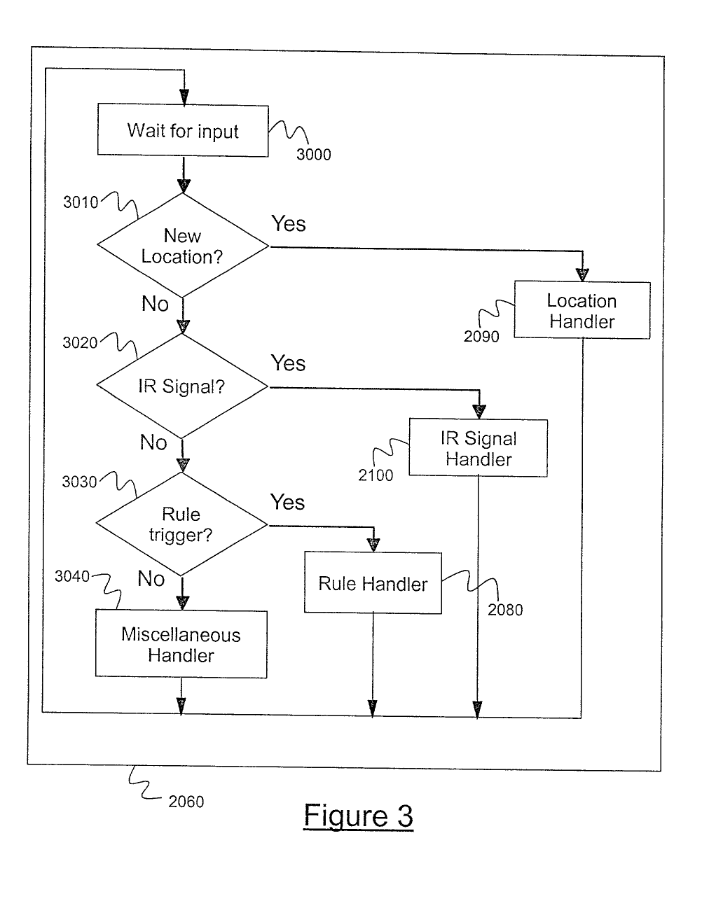

FIG. 3 is a block diagram of the program logic and flow of the MDP 2070. MDP 2070 receives input, block 3000, and forwards the input to an appropriate handler. The handlers include, inter alia, the IR Signal Processor 2030, GPS 2040, and the Rule Handler 2080. The handlers generate programmatic event flags (e.g., signaling that it is time for the MDD 1150a to update the display 2050 because the date has changed). An event flag can include, for example, the throwing of an instance of a Java Exception.

Referring to FIGS. 2 and 3, upon receiving input, the MDP 2070 determines the type of input. Upon determining the input is from the GPS 2040, block 3010, the Location Handler 2090 is invoked. The Location Handler 2090 receives the GPS input signal and determines a current location for the MDD 1150. For example, given a set of coordinates, e.g., latitude/longitude, the Location Handler 2090 can determine that the MDD 1150 is now in the College Campus 1020. Control continues at block 3000 once the Location Handler determines the current location. The GPS 2040 can refresh the positional information for the MDD 1150 continuously or periodically. The refresh rate can be set according to the application in which the MDD 1150 is deployed, for example, for a static MDD 1150, the position may be determined once.

If the input is not data from the GPS 2040, MDP 2060 determines whether the input is IR Signal data, block 3020. The IR Signal Handler 2100 is invoked upon determining IR signal input, program control continues at block 3000. The IR Signal Handler 2100 takes input from the IR Signal Processor 2030 and interprets it, generating programmatic event flags if appropriate. For example, if the IR Signal Processor 2030 receives an IR signal matching a pre-assigned password, e.g., one indicating that the sender of the IR Signal is a subscriber to a service (e.g., real-time stock quotes), the IR Signal handler can produce a programmatic event flag indicating that an authorized service viewer is requesting current data. One of ordinary skill in the art will appreciate that the IR signals can correspond to various types of requests. Given the IR signal, the IR Signal Handler can generate a programmatic even flag indicating the request for a stock quote. The IR Signal Handler 2100 can generate an IR signal using the IR Signal Processor 2030. Thus, for example, if the IR Signal Handler 2100 receives a signal indicating the service subscriber's user identification, the IR Signal Handler 2100 can respond with a prompt for a password, and wait for a valid response from the service subscriber before issuing an event flag to display the stock quote. One of ordinary skill in the art will recognize that the present invention can be used with other signal types, for example, radio frequency (RF) signals.

If the input is not an IR Signal, MDP 2070 determines whether the input is an event flag, block 3030. If not, a miscellaneous handler services the signal, block 3040. Program control is continued at block 3000. The miscellaneous handler can be, for example, an RF receiver which detects RF identifier tags (RF-ID tags) which can be worn by an individual or placed in a vehicle.

If the input is a rule trigger, Rule Handler 2080 is invoked, after the rule execution is complete, program control continues at block 3000. The Rule Handler 2080 receives an rule trigger, determines whether any of the rules held in the Rule Set 2120 are triggered, and allows each triggered rule to produce an associated action. These actions can include, for example, generating an event flag, changing of the data being displayed, adding a charge to the Accounting Database 2110, broadcasting, e.g., via the Wireless Communications Interface 2020 to an online billing service of all currently unreported charges stored in the Accounting Database 2110.

One with regular skill in art with appreciate that a rule can indicate that a particular set of data should be displayed given a particular combination of events. For example, a rule can indicate that a display business suit advertisement should be displayed during business hours while in the Business District 1030. The following pseudo-code illustrates a possible expression of this example:

IF ((IN “Business District”) AND (08:00<CURRENT_TIME<18:00)) THEN (DISPLAY business suit ads)

A rule can also indicate that given type of data should not be displayed given a particular set of conditions, for example, do not display smoking ads near the Elementary School 1090 during school hours. The following pseudo-code illustrates a possible expression of this example:

IF ((NEAR “Elementary School”) AND (09:00<CURRENT_TIME<15:00))

THEN (DO_NOT_DISPLAY smoking ads)

Similarly, a rule can specify that data should not be display unless there is someone there to see it. Such a rule may benefit advertisers, since they would not pay for the display of an ad in the absence of an audience. In this example, the function SPECTATOR_PRESENT could be governed by response from a ultrasonic proximity detector or the RF receiver which determines the presence of RF-ID tags. The following pseudo-code illustrates a possible expression of this example:

IF (NOT SPECTATOR_PRESENT)

THEN (DO_NOT_DISPLAY ALL)

A rule can also indicate how much to charge a content provider, such as an advertiser, for data displayed in particular situations. For example, charge double for advertisements shown near the toll plaza during rush hour where the potential customer base may be a captive audience. The following pseudo-code illustrates a possible expression of this example:

IF ((NEAR “Toll Plaza”) AND ((07:00<CURRENT_TIME<10:00) OR ((16:00<CURRENT_TIME<19:00))

THEN (CHARGE_FACTOR=2)

Rules can be written using any text editing application (e.g., vi, Notepad, etc.), the Rule Set 2120 can be, for example, a collection of data (e.g., a Java Vector) or a more structured database (e.g., IBM's DB2® database product). One with regular skill in the art will appreciate that a rule can be added to the Rule Set 2120 manually at the device or remotely, e.g., over a network.

MDD 1150 uses the information it receives to trigger rules. One type of information can be the identity, including demographic data, of those proximate to the MDD 1150. For example, if other cars pass the automobile 1110 emitting IR signals identifying themselves, then MDD 1150a can know who was able to look at the display. Demographic data can also be collected based on RF-ID tags detected by an RF receiver. Given the demographic data of the audience, rules based on demographics are possible. For example, a rule which doubles the charge associated with the display of an ad for a luxury car whenever a car adjacent to the display is a luxury car. The following pseudo-code illustrates a possible expression of this example:

IF (NEAR EXPENSIVE_CAR)

THEN ((DISPLAY expensive car ad) AND (CHARGE_FACTOR=2))

Knowing the identity and/or demographics of the audience enables an advertiser to correlate or target a marketing strategy more precisely to the environment, for which a premium can be extracted by the owner of the display.

MDD 1150 can send and receive IR signals via the IR Signal Processor 2030, and that MDD 1150 can determine how and what is displayed using the rules in the Rule Set 2120 and Rule Handler 2080. For two or more MDDs 1150 located near each other (where the IR signals sent from one IR Signal Processor 2030 can reach another), the MDDs can coordinate behavior. Coordination can include, inter alia, having multiple displays 2050 act as a single composite screen, where for example, each display shows a different section of the data. For example, for four MDDs within an area, such as standing on a line, the MDDs 2050 can be used as a single composite display for the display of an advertisement.

One with regular skill in the art will further appreciate that various parameters may be fixed for an MDD 1150. For example, referring to FIG. 1, an MDD 1150 may have a fixed position by the side of the Highway 1040 near the Toll Plaza 1050. While the positional parameter is fixed, other parameters are still applicable, such as time of day. An advantage of a fixed position MDD 1150 would be that if several such devices were deployed by a company (e.g., an advertising firm), each positioned in a place where the controller or owner of space was compensated for the device's display of content, each device could be programmed with the same set of rules, each device then functioning using its own unchanging location parameter.

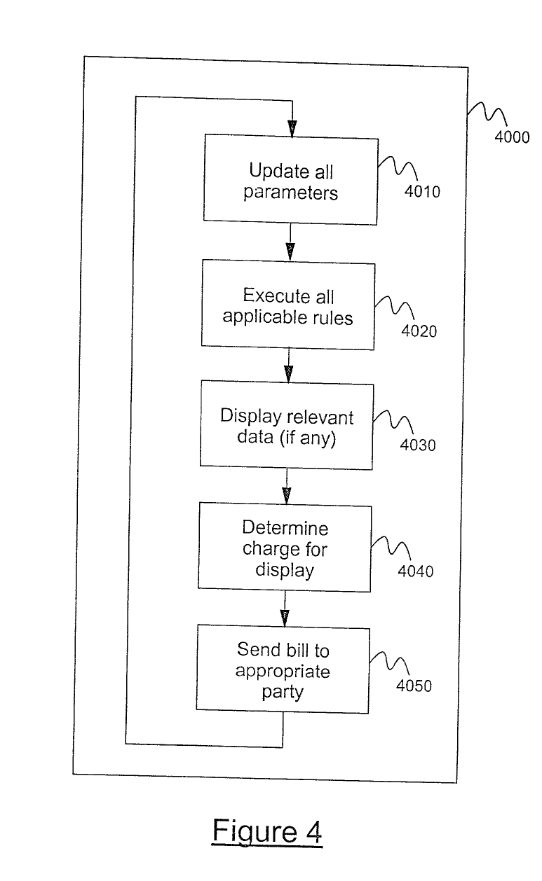

Referring to FIG. 4, the display device updates all available parameters, such as location, time/date, and IR signals, block 4010. The applicable rules are executed, these rules are held in the Rule Set 2120 and executed by the Rule Handler 2080, block 4020. All relevant data, if any, is displayed, block 4030. The charges for the display of the data are computed, block 4040, and these charges are sent the appropriate parties, block 4050. One with regular skill in the art will appreciate that an MDD could either send the bill directly to the responsible party (e.g., the advertiser), or to a single prearranged billing service that would then handle the location and collection of all bills, sending the payments to the MDD owner. The method 4000 then repeats starting at block 4010.

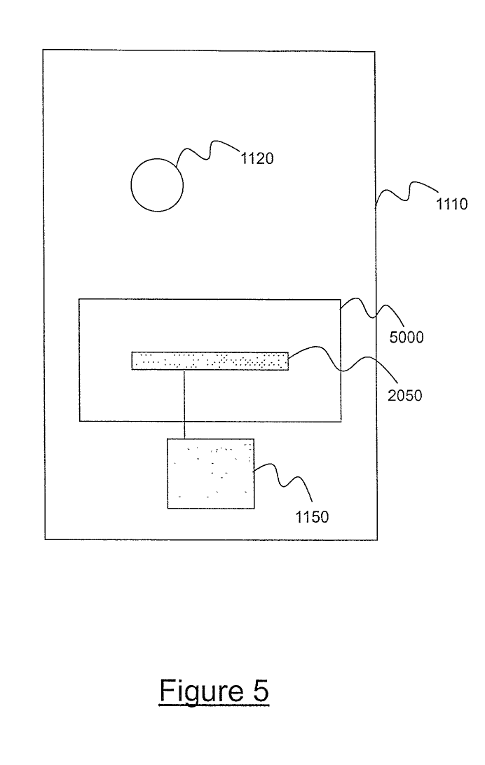

According to an embodiment of the present invention, a user 1120 can be paid by third parties (e.g., advertisers) for the display of data on the MDD 1150 they carry. MDD 1150a is carried by/in the automobile 1110 owned by driver 1120. FIG. 5 shows block diagram of this arrangement, which includes the automobile 1110, the driver 1120, and MDD 1150a located in the trunk. MDD 1150a has an external flat panel display 2050, for example, model 9513 flat panel display sold by IBM, which can be mounted just inside of the back window 5000. This allows people outside of the automobile to view the MDD 2050, while protecting it from the elements and vandalism.

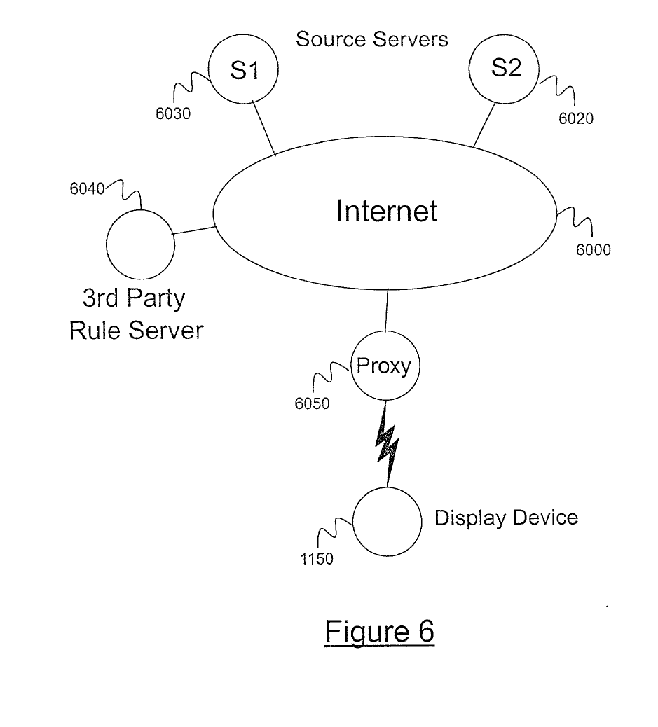

Referring to FIG. 6, the MDD 1150 contacts a source server 6020-6030 across a network, for example, including a proxy 6050 and the Internet 6000, from which the MDD 1150 retrieves display content and the display rules associated with advertisers. Alternatively, display content and display rules can be retrieved directly from a third-party Rule Server 6040. The rules are used to update the MDD's Rule Set 2120 (FIG. 2). The MDD 1150 displays ads for the advertisers, for example, a local coffee house, adding the charges to the Accounting Database 2110 (FIG. 2) each time the coffee house's ad is shown. The rate charged to the Accounting Database 2110 can be made variable so that, for example, within two blocks of the coffee house the rate for the display of the coffee house ad is increased. The rate change can occur automatically, for example, when the MDD 1150 determines that it within two blocks using the GPS 2040. One with ordinary skill in the art would appreciate that other environmental changes can trigger a change in the charge to the Accounting Database 2110.

As determined by the Rule Handler 2080, using the current rules in the Rule Set 2120, the advertisements which are displayed can change depending on any one or more of the parameters in the Rule Set 2120. For example, as MDD 1150a enters the Suburbs 1100, the advertisement for the local coffee house is no longer displayed but an advertisement for a show being performed at one of the city's theaters is displayed.

The owner of the MDD can add additional rules. For example, driver 1120 can add a rule to the Rule Set 2120, blocking displays of the advertisement for the show when the MDD 1150a is near the Elementary School 1090. The owner added rules override the rules provided by the advertiser. During the period while an ad is overridden, alternate content may be shown, for example, an add having rules which fit the parameters, for example, an advertisement for children's clothing.

An MDD 1150 can keep track of the charges for the data it has displayed using its Accounting Database 2110. These charges can be collected in a number of ways, including but not limited to: manually by the owner (e.g., sending a bill), automatically with a broadcast to the advertiser each time a charge is incurred, or via periodic broadcasts of the accumulated bills to the advertiser, via periodic broadcasts of the accumulated bills to a collection agency that, in turn, collects the funds from the associated advertisers and relays the payments back to the MDD owner.

Data displayed by MDD 1150 can be refreshed periodically using, for example, an HTTP-Get used to retrieve fresh content. The data can be cached in the display device's storage 2010 or at a remote server, for example, a third party server 6040 (FIG. 6). The data can be retrieved from a range of sources, including, but not limited to an HTTP server using either PUSH or PULL transfer protocols, television RF signals, or radio signals. Further, a single data source can provide the data for one or more advertiser (or paying data providers); such sources including caching proxy servers.

While embodiments of the present invention have been presented in the context of a single example, it should be noted that the MDD 1150 can be used in varying types of transactions. For example, the owner of an MDD 1150 can lease the MDD to a third party carrier and compensate the third party carrier with a portion of the proceeds.

Subscriptions can be sold for MDD users, wherein a user provides personal information which can be fed to an advertiser in order to determine desirable rules. For example, referring to FIG. 1, MDD 1150b carried by B 1140 has access to demographics concerning A 1130 viewing them because the information given by A 1130 can be associated with the personal ID the patron must specify must enter before any content is displayed by the display device 1150b. One with regular skill in the art will also appreciate that by using this demographic information, e.g., via rules, the MDD 1150b can both select the content and charge rates appropriate for the given user 1130.

According to another embodiment, a remote control device 1160 carrier by a user 1130 can emit a signal (e.g., an RF signal or IR signal) identifying the user. MDD 1150b can determine and customize its activity, including rates charged to users, to multiple spectators. Before displaying any data, the device 1150b can determine all user identifications within an area. Rule matching and charges would then be applied to all of the associated users. One with regular skill in the art will appreciate that B 1140 can also have been a remote control device, which she, could use to watch TV on an MDD carried by another.

Having described embodiments of a system and method for remotely configuring and displaying content, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A method for displaying content on a display device:
retrieving a plurality of rules for the display of content;
updating a plurality of device parameters;
determining an rule trigger;
executing a rule corresponding to the rule trigger; and
determining a fee according to at least one device parameter upon executing a rule for the display of content.

2. The method of claim 1, wherein at least one rule is defined by a content provider to dynamically control the display of the content according to the device parameters.

3. The method of claim 1, wherein the step of executing a rule further comprises the step of receiving a rule trigger from one of a location handler and a signal handler.

4. The method of claim 3, wherein the step of receiving a rule trigger from the location handler further comprises the step of updating a positional parameter.

5. The method of claim 3, wherein the step of receiving a rule trigger from the signal handler further comprises the steps of:
interpreting an input signal; and
generating a programmatic event flag.

6. The method of claim 5, wherein the step of generating a programmatic event flag further comprises the step of generating one of a reply signal and the rule trigger.

7. The method of claim 1, further comprising the step of providing an overriding rule blocking the display of content corresponding to the rule and the determination of the fee, wherein the overriding rule is defined by the device owner.

8. The method of claim 1, wherein the step of determining a fee further comprises the steps of:
determining a value for each of the device parameters;
determining at least one device parameter satisfying the rule; and
determining the fee according to value of the device parameters satisfying the rule.

9. The method of claim 8, further comprising the step of charging the fee to a client providing content to be displayed.

10. The method of claim 8, further comprising the step of apportioning the fee between a service provider and a third party carrier of the display device.

11. The method of claim 8, further comprising the step of apportioning the fee between an owner of the device and a third party carrier of the display device.

12. The method of claim 8, further comprising the step of apportioning the fee between a plurality of owners of a plurality of devices, wherein the devices act as a composite device.

13. The method of claim 1, wherein the fee is charged to a user for the use of the display.

14. A method for displaying content on a mobile display device:
retrieving a plurality of rules stored in the mobile display device from a rule server;
determining a value for each of a plurality of device parameters;
determining an rule trigger calling at least one rule;
determining whether each rule is satisfied by the device parameters;
displaying content corresponding to each satisfied rule; and
determining a monetary charge based on the device parameters satisfying each rule.

15. The method of claim 14, wherein at least one rule is defined by a content provider to dynamically control the display of the content according to the device parameters.

16. The method of claim 14, further comprising the step of receiving a rule trigger from one of a location handler and a signal handler.

17. The method of claim 16, wherein the step of receiving a rule trigger from the location handler further comprises the step of updating a positional parameter.

18. The method of claim 16, wherein the step of receiving a rule trigger from the signal handler further comprises the steps of:
interpreting an input signal; and
generating a programmatic event flag.

19. The method of claim 18, wherein the step of generating a programmatic event flag further comprises the step of generating one of a reply signal and the rule trigger.

20. A program storage device readable by machine, tangibly embodying a program of instructions executable by the machine to perform method steps for displaying content on a display device, the method steps comprising:
retrieving a plurality of rules for the display of content;
updating a plurality of device parameters;
determining an rule trigger;
executing a rule corresponding to the rule trigger; and
determining a fee according to at least one device parameter upon executing a rule for the display of content.

21. The program storage device of claim 18, wherein the method step of determining a fee further comprises the steps of:
determining a value for each of the device parameters;
determining at least one device parameter satisfying the rule; and
determining the fee according to value of the device parameters satisfying the rule.
